(19) United States
(12) Patent Application Publication
(10) Pub. No.: US 2016/0126572 A1
(43) Pub. Date: May 5, 2016

(54) FUEL CELL SYSTEM OPERATION METHOD USING TWO OR MORE POWER SUPPLIES

(71) Applicant: Hyundai Motor Company, Seoul (KR)

(72) Inventors: Young Min Kim, Yongin (KR); Seung Ki Yang, Yongin (KR); Sun Heum Baek, Yongin (KR)

(21) Appl. No.: 14/929,453

(22) Filed: Nov. 2, 2015

(30) Foreign Application Priority Data
Nov. 5, 2014 (KR) 10-2014-0152620

(51) Int. Cl. H01M 8/04

(52) U.S. Cl. CPC H01M 8/04559; H01M 8/0494; H01M 8/04947

(57) ABSTRACT

A fuel cell system and a fuel cell system operation method using two or more power supplies are provided. A main stack is operated to output constant voltage by receiving air and hydrogen of an air supply device and a fuel supply device. An initial average cell voltage of the main stack and an average cell voltage of the main stack are measured after 10 hours. The initial average cell voltage value and the measured average cell voltage value are compared to calculate a voltage reduction rate. The main stack up is operated when the voltage reduction rate is greater than the reference value and a sub power supply is operated until EOL is reached when the voltage reduction rate is greater than the reference value to increase operation efficiency.

### CROSS-REFERENCE TO RELATED APPLICATION

This application claims under 35 U.S.C. §119(a) the benefit of Korean Patent Application No. 10-2014-0152620 filed on Nov. 5, 2014, the entire contents of which are incorporated herein by reference.

### BACKGROUND

(a) Technical Field

The present invention relates to a fuel cell system. More particularly, the present invention relates to a fuel cell system operation method using two or more power supplies, which increases operation efficiency by operating a fuel cell system by avoiding a low-efficiency operation region interval generated by voltage drop in constant voltage operation and alleviate a deterioration speed and rapidly restore an initial performance due to a main stack having a pause period.

(b) Background Art

In general, a fuel cell is a type of power generation device that includes a fuel cell stack that generates electric energy from an electrochemical reaction of reaction gas and can be applied to power for industry, home, and driving a vehicle and supply of power for small-sized electric/electronic products, in particular, portable devices.

As an example of the fuel cell, a polymer electrolyte membrane fuel cell or proton exchange membrane fuel cell (PEMFC) serving as a power source for driving a vehicle includes a membrane electrode assembly (MEA) in which catalyst electrode layers in which an electrochemical reaction occurs are attached to both sides of a membrane around an electrolyte membrane in which hydrogen ions move, a gas diffusion layer (GDL) that serves to evenly distribute reaction gas and transfer generated electric energy, a gasket and a fastening mechanism for maintaining airtightness (e.g., an airtight seal) and appropriate fastening pressure of the reaction gas and cooling water, and a bipolar plane that moves the reaction gas and the cooling water.

In the fuel cell, hydrogen as fuel and oxygen (air) as an oxidizer are supplied to an anode and a cathode of the membrane electrode assembly through a flow path of the bipolar plane, respectively, and the hydrogen is supplied to the anode (also referred to as ‘fuel electrode’, ‘hydrogen electrode’, or ‘oxide electrode’) and the oxygen (air) is supplied to the cathode (also referred to as ‘air electrode’, ‘oxygen electrode’, or ‘reduction electrode’). The hydrogen supplied to the anode is resolved into hydrogen ions (proton, H+) and electrons (e−) by catalysts of electrode layers configured at both sides of the electrolyte membrane and the hydrogen ions among them selectively pass through the electrolyte membrane which is a positive ion exchange membrane to be transferred to the cathode and simultaneously, the electrons are transferred to the cathode through the gas diffusion layer and the bipolar plane as conductors. In the cathode, a reaction is caused, in which the hydrogen ions supplied through the electrolyte membrane and the electrons transferred through the bipolar plane meet oxygen in the air supplied to the cathode by an air supply device to generate water. The electrons flow through an external conductive wire due to movement of the hydrogen ions, which occurs at that time and current is generated by the flow of the electrons.

Meanwhile, when the fuel cell is used as a power source of the vehicle, since the fuel cell takes charge of all loads constituting the vehicle, it is disadvantageous that performance deterioration occurs in an operation region in which efficiency of the fuel cell is substantially low. Further, sufficient voltage required by a drive motor cannot be supplied due to an output characteristic in which output voltage rapidly decreases in a high-speed operation region requiring high voltage, and as a result, an acceleration performance deteriorates.

Accordingly, dry out (e.g., when vapor containing water drops contacts a heating surface, the water drop absorbs heat to be evaporated) of the fuel cell in the constant voltage operation and a saw tooth effect in which efficiency of the cell rapidly deteriorates with time when catalyst contamination or deterioration occurs at a predetermined potential, and as a result, an operation method that can overcome the efficiency deterioration and maintain high operation efficiency in a constant current operation needs to be presented.

The above information disclosed in this section is merely for enhancement of understanding of the background of the invention and therefore it may contain information that does not form the prior art that is already known in this country to a person of ordinary skill in the art

### SUMMARY

The present invention provides a fuel cell system operation method that increases operation efficiency by avoiding a low-efficiency operation region interval generated by voltage drop in a constant voltage operation by alternately operating a main stack and a sub stack or a battery which are two or more power supplies, and alleviate a deterioration speed based on an operation and rapidly restore an initial performance due to a pause period of the main stack.

In one aspect, the present invention provides a fuel cell system operation method using two or more power supplies that may include: operating a main stack in the power supplies for outputting substantially constant voltage by receiving air and hydrogen from an air supply device and a fuel supply device; measuring and storing initial average cell voltage of the main stack using a voltage measurer (e.g., sensor); measuring and storing average cell voltage of the main stack every set time by the voltage measurer; comparing the initial average cell voltage and the measured average cell voltage to calculate a voltage reduction rate of the measured average cell voltage based on the initial average cell voltage and comparing the calculated voltage reduction rate and a reference value; and transferring constant voltage of the main stack to a power distributing device when the voltage reduction rate is less than the reference value.

The present invention is provided to increase operation efficiency by operating a fuel cell system through avoiding a low-efficiency operation region interval generated by voltage drop in a constant voltage operation by operating the fuel cell system with two or more power supplies, and alleviate a deterioration speed based on an operation and rapidly restore an initial performance because the main stack has a pause period.

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIG. 1 is a diagram showing a fuel cell system operation method using two or more power supplies according to an exemplary embodiment of the present invention;

FIG. 2 is a flowchart of the fuel cell system operation method using two or more power supplies according to an exemplary embodiment of the present invention; and

FIGS. 3A-3B are graphs comparing efficiency of the operation method of an exemplary embodiment of the present invention and efficiency of the existing operation method according to the related art.

Reference numerals set forth in the Drawings includes reference to the following elements as further discussed below:
10: air supply device
20: fuel supply device
30: power supply
40: main stack
50: sub power supply (sub stack or battery)
60: power distributing device

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, an and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail with reference to the accompanying drawings, so as to be easily implemented by those skilled in the art.

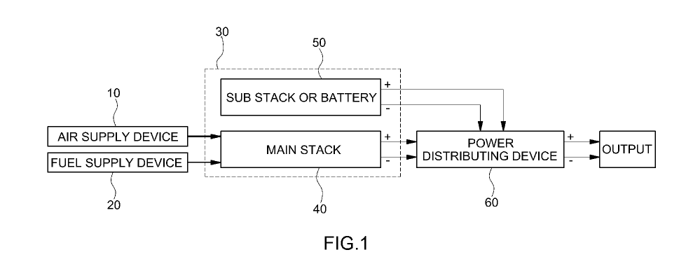

Prior to describing a fuel cell system operation method using two or more power supplies, as illustrated in FIG. 1, as a basic configuration for a drive part of a fuel cell vehicle may include a fuel supply device 20 configured to supply hydrogen as fuel to a power supply 30 and an air supply device 10 configured to supply air as an oxidizer; a main stack 40 disposed in the power supply device 30; and a power distributing device 60 configured to supply power to a motor which is a drive source by receiving substantially constant voltage produced by the main stack 40 and disposed at a rear stage.

Herein, a sub stack 50 that substitutes for the main stack 40 which the power supply 30 may be further provided and the sub stack 50 may have the same structure as the main stack 40. Meanwhile, the sub stack 50 may be replaced with a battery charged with external power instead of the sub stack 50. Accordingly, in the exemplary embodiment of the present invention, as another power supply 50 distinguished from the main stack 40 which is one of the plurality of power supplies 30 of the fuel cell vehicle, the sub stack or battery may be used, and therefore, hereinafter, the sub stack or battery will be referred to as a sub power supply (e.g., sub stack or battery 50) to distinguish from the main stack 40 which is a main power supply.

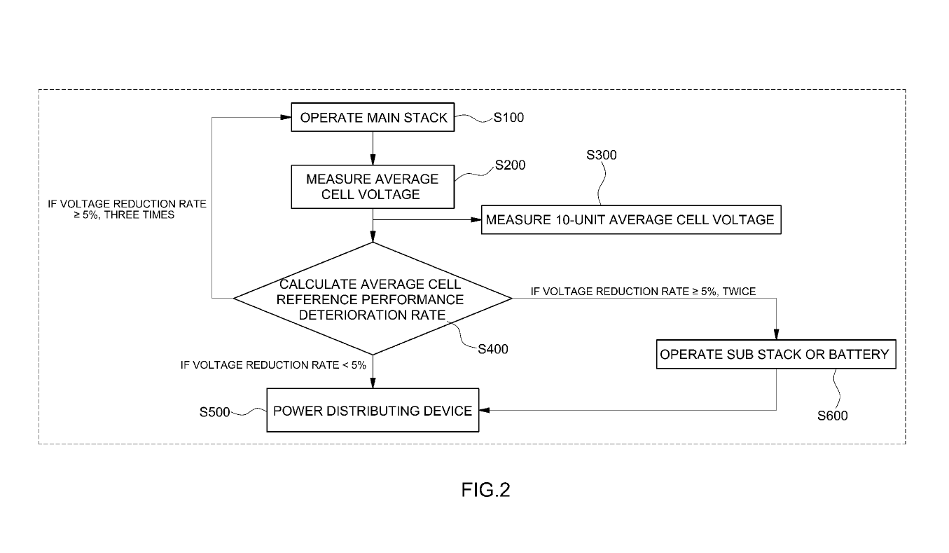

In the fuel cell system operation method according to an exemplary embodiment of the present invention, a fuel cell stack as the main power supply, that is, the main stack 40 may first be operated among the power supplies 30 to output substantially constant voltage by supplying air and hydrogen by the air supply device 10 and the fuel supply device 20 as illustrated in FIG. 2 (S100). In particular, initial average cell voltage of the main stack 40 may be measured using a voltage measurer (e.g., a sensor or other measuring device) and the measured initial average voltage value may be stored (e.g., in a memory of the controller) (S200).

Meanwhile, an average cell voltage of the main stack 40 may be measured every set time using the voltage measurer while the main stack 40 is operated and the measured average cell voltage value may be stored in a memory (S300). Herein, the set time may be determined as about 10 hours, and as a result, the average cell voltage of the main stack 40 may be measured per 10 hours.

Further, the initial average cell voltage value and the measured average cell voltage value may be compared to calculate a voltage reduction rate of the average cell voltage based on the initial average cell voltage and compare the calculated voltage reduction rate with a predetermined reference value (S400). These processes may be executed by a controller of the system. As the voltage reduction rate is determined by the reference voltage comparison step (S400), when the voltage reduction rate is less than the reference value, the constant voltage of the main stack 40 may be transferred to the power distributing device 60 (S500) to supply power to drive a drive motor.

According to the determination of the voltage comparison step (S400), when the voltage reduction rate is equal to or greater than the reference value, the transferring of the constant voltage to the power distributing device 60 may be executed by stopping the operation of the main stack 40 and operating the sub power supply (e.g., sub stack or battery 50).

Herein, operating the sub power supply 50 means a state in which when the sub power supply is another fuel cell stack, that is, the sub stack distinguished from the main stack 40, the fuel supply device 20 may be configured to supply hydrogen as the fuel and the air supply device 10 may be configured to supply air as the oxidizer, and as a result, the sub stack may be operated to produce power. In particular, the sub stack may be configured to supply power to the motor as the drive source of the vehicle, and the like. Further, operating the sub power supply 50 means that the power charged in the battery is configured to be supplied to the motor as the drive source of the vehicle, and the like through the power distributing device 60 when the sub power supply 50 is the battery.

Meanwhile, in the step (S400) of comparing the initial average cell voltage and the average cell voltage measured every set time, the sub power supply 50 may be operated to supply the power continuously until the average cell voltage reduction rate of the main stack 40 is greater than the reference value. Additionally, in the step (S400) of comparing the initial average cell voltage and the average cell voltage measured every set time, the sub power supply 50 may be stopped and only the main stack 40 may be operated until reaching an end of life (EOL) to supply the power when the number of times when the average cell voltage reduction rate of the main stack 40 is equal to or greater than the reference value is the set number of times.

Stopping the sub power supply means stopping the sub stack or interrupting the supply of the power from the battery. In particular, the set number of times may be determined as twice and the reference value used in the reference comparing step (400) may be determined as about 5% as the voltage reduction rate based on the initial average cell voltage.

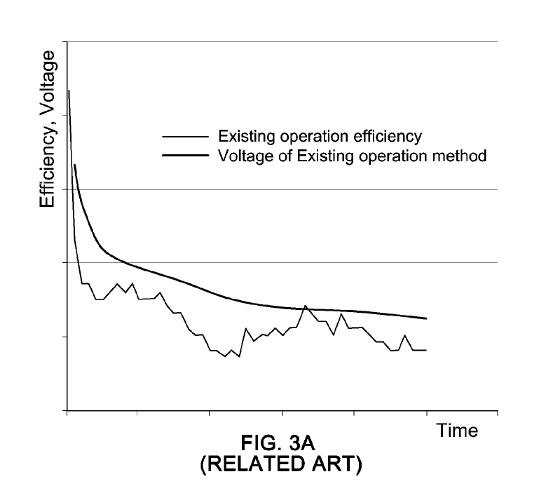

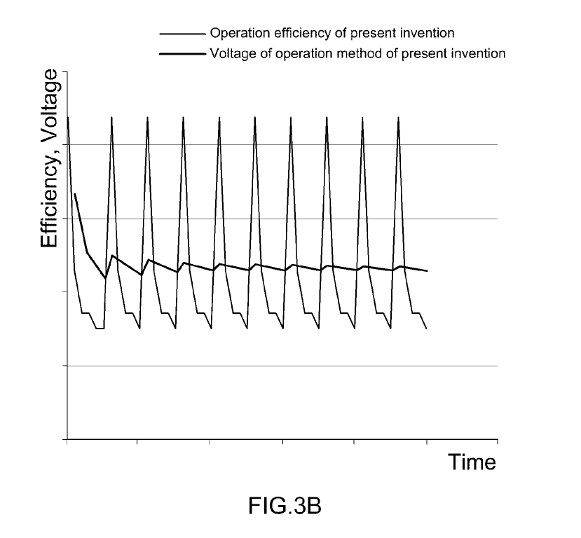

By the fuel cell system operation method using two or more power supplies according to an exemplary embodiment of the present invention, as illustrated in FIG. 3A according to the related art, cumulative operation efficiency continuously decrease up to 54% or less starting from 56% or greater in the existing operation method. However, as illustrated in FIG. 3B, in the fuel cell system operation method using two or more power supplies according to the present invention, since operation efficiency of a predetermined level or greater may be maintained by alternately operating the main stack 40 which is the main power supply and the sub power supply (sub stack or battery 50), an increase in operation efficiency may be anticipated as compared with the existing operation method of the related art.

The present invention is provided to increase operation efficiency by operating a fuel cell system through avoiding a low-efficiency operation region interval generated by voltage drop in a constant voltage operation by operating the fuel cell system with two or more power supplies, and alleviate a deterioration speed based on an operation and rapidly restore an initial performance due to a pause period of the main stack.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A fuel cell system operation method using two or more power supplies, comprising:
operating, by a controller, a main stack for outputting a constant voltage by receiving air by an air supply device and receiving hydrogen by a fuel supply device;
measuring and storing, by a voltage sensor, an initial average cell voltage of the main stack;
measuring and storing, by the voltage sensor, an average cell voltage of the main stack every set time;
comparing, by the controller, the initial average cell voltage and the measured average cell voltage to calculate a voltage reduction rate of the measured average cell voltage based on the initial average cell voltage and comparing the calculated voltage reduction rate and a reference value; and
transferring, by the controller, the constant voltage of the main stack to a power distributing device when the voltage reduction rate is less than the reference value.

2. The method of claim 1, further comprising:
transferring, by the controller, the constant voltage to the power distributing device by stopping the main stack and operating a sub power supply when the voltage reduction rate is equal to or greater than the reference value.

3. The method of claim 2, wherein the transferring of the constant voltage to the power distributing device is maintained by operating the sub power supply until the number of times when the voltage reduction rate is equal to or more than the reference value becomes the predetermined number of times.

4. The method of claim 2, wherein the sub power supply is stopped and the main stack is operated when the number of times when the voltage reduction rate is equal to or greater than the reference value exceeds the predetermined number of times.

5. The method of claim 2, wherein the sub power supply is a sub stack provided separately from the main stack and operated by receiving air and hydrogen by the air supply device and the fuel supply device.

6. The method of claim 2, wherein the sub power supply is a battery.

7. The method of claim 1, wherein the reference value is about 5% as the voltage reduction rate based on the initial average cell voltage.

8. A fuel cell system, comprising:
a fuel supply device configured to supply hydrogen as fuel to a power supply;
an air supply device configured to supply air as an oxidizer to the power supply;
a main stack disposed in the power supply device;
a voltage sensor configured to measure and store an initial average cell voltage of the main stack and an average cell voltage of the main stack every set time;
a power distributing device configured to supply power to a motor by receiving constant voltage produced by the main stack when a voltage reduction rate of the measured average cell voltage based on the initial average cell voltage is less than a reference value.
